(19) United States
(12) Patent Application Publication
(10) Pub. No.: US 2007/0180926 A1
(43) Pub. Date: Aug. 9, 2007

(54) TEST DEVICE FOR A FOLDABLE OBJECT

(75) Inventors: Jie Huang, Hubei Province (CN); Chia-En Lee, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/669,195

(22) Filed: Jan. 31, 2007

(30) Foreign Application Priority Data
Feb. 6, 2006 (TW) 95103899

(51) Int. Cl. G01N 3/08

(52) U.S. Cl. 73/818

(57) ABSTRACT

A test device for a foldable object is provided. The device comprises a frame, an external balloon and an internal balloon. The external balloon is disposed on the frame, and the internal balloon is disposed on an inner surface of the foldable object. When the internal balloon expands, it provides a first thrust to unfold the foldable object, and when the external balloon expands, it provides a second thrust to fold the foldable object. A folding test on a foldable object is performed accordingly.

This application claims the benefit of Taiwan application Serial No. 95103899, filed Feb. 6, 2006, the subject matter of which is incorporated herein by reference.

### BACKGROUND OF THE INVENTION

1. Field of the Invention

The invention relates in general to a test device, and more particularly to a test device for a foldable object.

2. Description of the Related Art

Along with the development of technology, many electronic products, such as foldable mobile phone, notebook, and electronic translator, have shifted from single-pieced structure to double-pieced foldable structure. The key point in the design of the foldable object is the lifespan of the switch mechanism. After a foldable product is manufactured completely, the test to make sure whether the lifespan of the switch mechanism meets the standard is performed. Currently, there are two types of testing method available: one is to employ manual folding/unfolding while the other is to perform folding/unfolding movement by a mechanical arm. The manual test is closer to realities in actual use, however, the human factors are hard to be controlled during the test and it takes more cost. And despite the mechanical arm has been widely used in the folding test of electronic products, it may cause negative effects. For example, when the mechanical arm moves, the incurred friction may cause the foldable products to wear and tear, and the accuracy of the folding test is not so high due to the discrepancies between the testing environment and the actual working environment of the products.

The electronic product having a mechanical arm for the folding test now can simulate the folding/unfolding movement of the cover is provided. It also allows the user to set the rotation angle and frequency before the folding test is performed. Referring to FIG. 1, a diagram of conventional folding test device is shown. The body 11 of the foldable object is fixed on a fixing surface 110 of a testing platform, and the folding/unfolding of the cover 12 is simulated using a mechanical arm 130 similar to a driving lever. The maximum rotation angle between the body 11 and the cover 12 is β. The determined rotation angle is not larger than the maximum rotation angle β. When the folding test is performed within the range of the determined rotation angle, the mechanical arm 130 pushes the cover 12, so the cover 12 is unfolded by a thrust from the mechanical arm 130. The magnitude of the thrust is controlled by the speed of the mechanical arm 130. During the folding test, because the mechanical arm 130 contacts to the cover 12, an undesired friction is created at the contact surface between the mechanical arm 130 and the cover 12. If the strength of the material of the mechanical arm 130 is higher than that of the cover 12, the cover 12 might be damaged easily. Besides, the thrust provided by the mechanical arm is not small; a larger fixing force of the fixing surface 110 may have to be provided to fix the foldable objects, particularly the mobile phone whose size is small, lest the foldable object might comes off from the fixing surface 110 of the testing platform easily. However, as the fixing force creates extra tension between the body 11 and the cover 12, the friction generated during folding/unfolding may break the shaft or other components connecting the two elements. Besides, there are discrepancies between simulated operation and actual working environment, such that the reliability of the testing results is not so satisfactory.

### SUMMARY OF THE INVENTION

It is therefore an object of the invention to provide a test device for a foldable object, not only increasing the accuracy of the folding test, but also reducing abrasion and damage of the foldable object during the testing process.

The invention achieves the above-identified object by providing a test device for a foldable object. The device comprises a frame, an external balloon and an internal balloon. The external balloon is disposed on the frame. The internal balloon is disposed on an inner surface of the foldable object. When the internal balloon expands, the internal balloon provides a first thrust to unfold the foldable object, and when the external balloon expands, the external balloon provides a second thrust to fold the foldable object. A folding test on a foldable object is performed accordingly.

In the above preferred embodiment, the expansion and contraction of the balloon is achieved by the mechanism of a cylinder and a piston.

In the above preferred embodiment, the piston is connected to a driving device, such that continuous reciprocal movement of the piston is achieved, and the folding test on the foldable object is performed continuously.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of conventional folding test device;

FIG. 2 is a diagram of a folding test device according to a preferred embodiment of the invention; and

FIG. 3 is a diagram showing the principles of the movements of a folding test device according to a preferred embodiment of the invention.

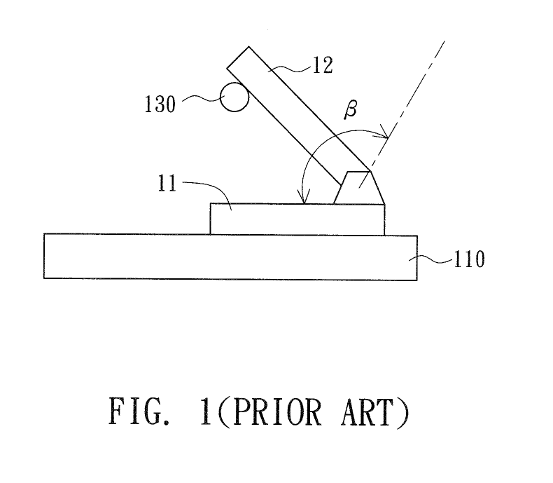

### DETAILED DESCRIPTION OF THE INVENTION

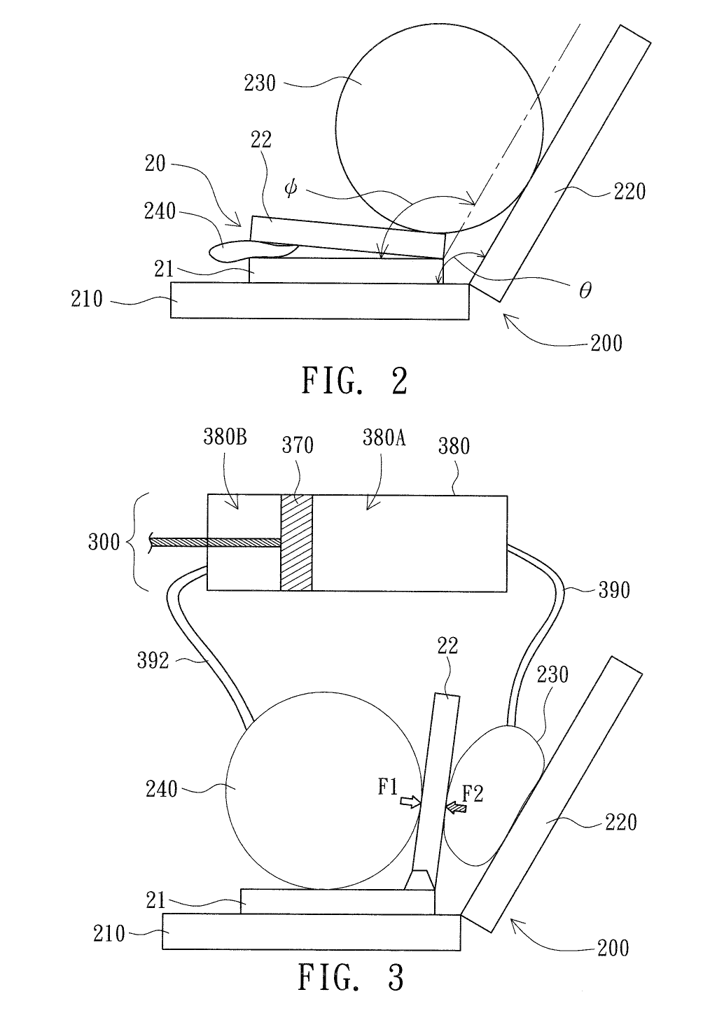

Referring to FIG. 2, a diagram of a folding test device according to a preferred embodiment of the invention is shown. The folding test device of the invention is for performing a folding test on the foldable object 20. Examples of the foldable object 20 include foldable mobile phone, notebook, electronic translator, or other foldable devices with a body 21 and a cover 22. As indicated in FIG. 2, the folding test device comprises a frame 200, an external balloon 230 and an internal balloon 240. The frame 200 comprises a fixing surface 210 and a ramp 220. The ramp 220 is an adjustable ramp, and forms an included angle θ with the fixing surface 210. The foldable object 20 is disposed on the fixing surface 210, and the body 21 is disposed on the fixing surface 210 and forms a maximum rotation angle φ with the cover 22. The included angle θ is not smaller than the maximum rotation angle φ, and is adjusted with reference to the maximum rotation angle φ. The external balloon 230 is disposed on the ramp 220 of the frame 200. The internal balloon 240 is disposed on an inner surface of the foldable object 20. For example, the internal balloon 240 is attached on an inner surface of the cover 22 or an inner surface of the body 21.

Referring to FIG. 3, a diagram showing the principles of the movements of a folding test device according to a preferred embodiment of the invention is shown. The folding test device comprises a gas controller 300, a first hose 390 and a second hose 392. The gas controller 300 is for controlling the gas flux of the external balloon 230 and the internal balloon 240. As indicated in FIG. 3, the expansion and contraction of the external balloon 230 and the internal balloon 240 are controlled by the gas controller 300. The gas controller 300 comprises a cylinder 380 and a piston 370. The cylinder 380 has a cylinder chamber. The piston 370 is moveably disposed inside the cylinder chamber to control the gas to enter/leave the cylinder 380, and divides the cylinder chamber into a first chamber 380A and a second chamber 380B. The external balloon 230 is connected to the first chamber 380A via the first hose 390. The internal balloon 240 is connected to the second chamber 380B via the second hose 392.

When the piston 370 moves towards the second hose 392, the piston 370 pushes part of the gas in the second chamber 380B to the internal balloon 240 but infuses part of the gas in the external balloon 230 into the first chamber 380A, such that the internal balloon 240 expands but the external balloon 230 contracts. That is, the internal balloon 240 provides a first thrust F1 for moving the cover 22 towards the ramp 220 to simulate the actual movement of unfolding the cover 22 manually. When the piston 370 moves towards the first hose 390, the piston 370 pushes part of the gas in the first chamber 380A to the external balloon 230 but infuses part of the gas in the internal balloon 240 into the second chamber 380B, such that the external balloon 230 expands but the internal balloon 240 contracts. That is, the external balloon 230 applies a second thrust F2 on the cover 22 for moving the cover 22 towards the body 21 to simulate the actual movement of folding the cover 22 manually.

In the present embodiment of the invention, the piston 370 is connected to a driving device, such that the piston 370 moves reciprocally, and the folding test on a foldable object is performed continuously.

Preferably, the property of the material (such as rubber) used as the external balloon 230 and the internal balloon 240 is similar to that of human skin, so the simulated movement of the cover 22 during the test is close to actual working environment. By means of the external and the internal balloon filled with gas, the foldable object and peripheral elements will not be abrased or damaged.

The folding test device disclosed in the above embodiment of the invention controls the expansion and contraction of the external and the internal balloons by a gas controller, such that the folding and unfolding movements of the foldable object are simulated. Not only the accuracy of the folding test is increased, the abrasion or damage of the foldable object is also reduced during the test process because the property of the material used as the external and the internal balloons is similar to that of human skin.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A test device for a foldable object comprising:
a frame used for fixing a foldable object;
an external balloon disposed on the frame; and
an internal balloon disposed on an inner surface of the foldable object;
wherein, when the internal balloon expands, the internal balloon provides a first thrust to unfold the foldable object, and when the external balloon expands, the external balloon provides a second thrust to fold the foldable object, such that a folding test on a foldable object is performed.

2. The folding test device according to claim 1, wherein the foldable object has a maximum rotation angle, the frame comprises:
a fixing surface for placing the foldable object; and
a ramp forming an included angle not smaller than the maximum rotation angle with the fixing surface.

3. The folding test device according to claim 2, wherein the ramp is adjustable, and the included angle is adjusted according to the maximum rotation angle.

4. The folding test device according to claim 2, wherein the foldable object comprises a cover and a body, the body is disposed on the fixing surface, and when the internal balloon expands, the cover is moved towards the ramp by the first thrust to unfold the foldable object.

5. The folding test device according to claim 4, wherein the external balloon is attached on the ramp, and when the external balloon expands, the cover is moved towards the body by the second thrust to fold the foldable object.

6. The folding test device according to claim 5, wherein the internal balloon is attached on an inner surface of the cover.

7. The folding test device according to claim 5, wherein the internal balloon is attached on an inner surface of the body.

8. The folding test device according to claim 1, wherein the device comprises a gas controller used for controlling the gas fluxes of the external and the internal balloons for enabling the external and the internal balloon to expand or contract.

9. The folding test device according to claim 8, wherein the gas controller comprises:
a cylinder having a cylinder chamber; and
a piston moveably disposed inside the cylinder chamber for controlling the gas to enter or leave the cylinder.

10. The folding test device according to claim 9, wherein the cylinder chamber is divided into a first chamber and a second chamber by the piston, the device further comprises:
a first hose connecting the first chamber to the external balloon; and
a second hose connecting the second chamber to the internal balloon;
when the piston moves towards the first hose, the piston pushes part of the gas of the first chamber to the external balloon but infuses part of the gas of the internal balloon into the second chamber, such that the external balloon expands but the internal balloon contracts for enabling the external balloon to provide the second thrust to fold the foldable object;
when the piston moves towards the second hose, the piston infuses part of the gas of the external balloon into the first chamber but pushes part of the gas of the second chamber to the internal balloon, such that the external balloon contracts but the internal balloon expands for enabling the internal balloon to provide the first thrust to unfold the foldable object.

11. The folding test device according to claim 10, wherein the piston is connected to a driving device for enabling the piston to move reciprocally such that the test is performed continuously.

12. The folding test device according to claim 1, wherein the material of the external and the internal balloons is similar to human skin.
